(19) United States
(12) Patent Application Publication
(10) Pub. No.: US 2004/0245764 A1
(43) Pub. Date: Dec. 9, 2004

(54) Photo-luminescent marking of identification cards for security and rescue situations

(76) Inventor: Charles J. Bolta, Ft. Collins, CO (US)

Correspondence Address: Emery L. Tracy, P.O. Box 1518, Boulder, CO, 80306-1518, US

(21) Appl. No.: 10/863,788

(22) Filed: Jun. 8, 2004

Related U.S. Application Data
(60) Provisional application No. 60/476,991, filed on Jun. 9, 2003.

(51) Int. Cl. B42D 15/00

(52) U.S. Cl. 283/75

(57) ABSTRACT

A badge device for identifying a person or object is provided. The badge device comprises a card substrate, a photo-luminescent marking applied to the card substrate, and a reflective marking applied to the card substrate.

The present application is a continuation of pending provisional patent application Serial No. 60/476,991, filed on Jun. 9, 2003, entitled “Photo-Luminescent Marking of Identification Cards With Colored Luminescent Crystals for Security and Rescue That Indicates Building Locations”.

### BACKGROUND OF THE INVENTION

1. Field of the Invention

This invention relates generally to identification cards and, more particularly, the invention relates to identification cards having photo-luminescent markings for security and rescue situations.

2. Description of the Prior Art

With the growing need for security in the work place, many companies are providing their employees with identification badges or “IDs” that include the employee's picture and other important identifying information, such as the employee's name and employment position. In many instances, employees are required to maintain the ID on his or her person while at work, and may even be required to display the ID while at work so that security personnel can examine the photograph on the ID.

Unfortunately, during low light situations such as power loss and nighttime, it is often difficult for security personnel to accurately view the identification cards or review the information on the identification cards. The inability to view the identification card in low light situations impedes the security personnel from seeing the person wearing the identification card. An inaccurate reading or understanding of the information on the identification cards can lead to security breaches and unwanted or non-authorized personnel entering restricted areas.

Accordingly, there exists a need for photo-luminescent marking of identification cards for security and rescue operations which are visible to security personnel and others during low light situations. Additionally, a need exists for photo-luminescent marking of identification cards for security and rescue operations for indicating position within a building for visibility in darkness or low light conditions. Furthermore, there exists a need for photo-luminescent marking of identification cards for security and rescue operations for assisting in traffic self-management or rescue retrieval.

### SUMMARY

The present invention is a badge device for identifying a person or object. The badge device comprises a card substrate, a photo-luminescent marking applied to the card substrate, and a reflective marking applied to the card substrate.

In addition, the present invention includes a badge device for identifying a person or object. The badge device comprises a card substrate, a photo-luminescent marking applied to the card substrate, and a reflective marking applied to the card substrate.

The present invention further includes a method for identifying a person or object in low light situations. The method comprises applying a photo-luminescent marking applied to the card material and coloring the photo-luminescent marking for particularly identifying the person or object.

### BRIEF DESCRIPTION OF THE DRAWINGS

FIG. 1 is an elevational front view illustrating an identification card, constructed in accordance with the present invention, having photo-luminescent markings for security and rescue operations.

### DETAILED DESCRIPTION OF THE PREFERRED EMBODIMENTS

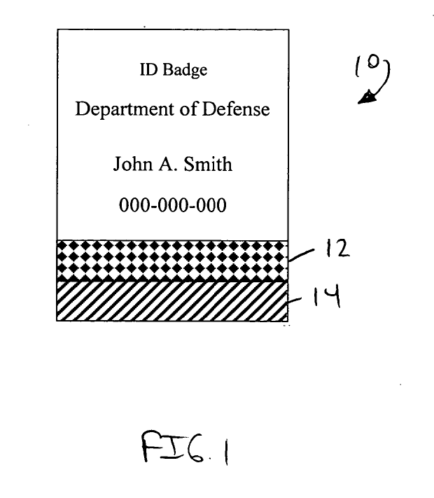

As illustrated in FIG. 1, the present invention is an identification card, indicated generally at 10, having photo-luminescent markings 12 for security and rescue operations. The photo-luminescent markings 12 can be applied to the identification card 10 using colored crystals indicating position within a building for visibility in darkness or low light conditions.

Using photo-luminescent markings or crystals 12 to mark the identification cards 10 with colored luminescent crystals indicates the individual's occupancy location within a building. Charging the identification card or badge 10 with a light source (not shown) before or during an event of darkness or low light illumination can help in traffic self-management or rescue retrieval.

The photo-luminescent markings 12 can include powders dissolved in solution so as to be printed to convey information in darkness or low light areas. Photo-luminescent materials 12 and reflective materials 14can be applied to the identification cards or badges 10 for correctional facilities, homeland defense personnel, and visitors, as well as expected employees can be identified for security with different colored photo-luminescent crystals 12. Traffic self-management can direct personnel to exits by matching the identification badges or cards 10 with placards that indicate shortest egress paths that can also be marked with matching color.

Security personal can take the identification cards 10 and cup in their hands to create a dark environment and see the photo-luminescent material 12 glow reducing fraud of unauthorized identification cards. With the identification cards 10 of the present invention, this can occur without specialized equipment such as ultra-violet makings.

The identification cards 10 of the present invention uses photo-luminescent markings 12 that are independent of language for indicating building area to personnel for security purposes. The identification cards 10 with the photo-luminescent markings 12 for can indicate egress information by matching the wearers' color to a placard of same color to indicate egress paths. Marking of hazardous materials and packages for transport within a facility can also be accomplished so that appropriate materials follow appropriate paths within a facility during periods of no or low light.

In another embodiment of the identification card 10 of the present invention, photo-luminescent material 12 and reflective material 14 are constructed into the plastic casing of the identification card 10 in specific area that only security personal would know of.

In sum, the identification card 10 of the present invention uses photo-luminescent markings or crystals 12 to mark identification cards 10 with colored luminescent crystals to indicate the individual's occupancy location within a building. Charging the identification card or badge 10 with a light source before or during an event of darkness or low light illumination assists in traffic self-management or rescue retrieval.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein, may be suitably practiced in the absence of the specific elements which are disclosed herein.

What is claimed is:

1. An identification card for identifying a person or object, the identification card comprising:
a card material; and
a photo-luminescent marking applied to the card material.

2. The identification card of claim 1 wherein the photo-luminescent marking is constructed from photo-luminescent powders dissolved in solution.

3. The identification card of claim 1 wherein the photo-luminescent marking is colored.

4. The identification card of claim 3 wherein each color represents occupancy location within a building.

5. The identification card of claim 3 wherein each color represents shortest egress paths from a building.

6. The identification card of claim 3 wherein each color represents a particular hazardous material and package for transport within a facility.

7. The identification card of claim 1 and further comprising:
a reflective marking applied to the card material.

8. The identification card of claim 1 and further comprising:
a clear plastic material surrounding at least a portion of the card material; and
a photo-luminescent marking on the plastic material.

9. The identification card of claim 8 and further comprising:
a reflective marking applied to the plastic material.

10. A badge device for identifying a person or object, the badge device comprising:
a card substrate;
a photo-luminescent marking applied to the card substrate; and
a reflective marking applied to the card substrate.

11. The badge device of claim 10 wherein the photo-luminescent marking is colored.

12. The badge device of claim 1 1 wherein each color represents occupancy location within a building.

13. The badge device of claim 11 wherein each color represents shortest egress paths from a building.

14. The badge device of claim 11 wherein each color represents a particular hazardous material and package for transport within a facility.

15. The badge device of claim 10 and further comprising:
a clear plastic material surrounding at least a portion of the card substrate; and
a photo-luminescent marking on the plastic material.

16. The badge device of claim 15 and further comprising:
a reflective marking applied to the plastic material.

17. A method for identifying a person or object in low light situations, the method comprising:
applying a photo-luminescent marking applied to the card material; and
coloring the photo-luminescent marking for particularly identifying the person or object.

18. The method of claim 17 and further comprising:
coloring the photo-luminescent to represent occupancy location within a building.

19. The method of claim 17 and further comprising:
coloring the photo-luminescent to represent shortest egress paths from a building.

20. The method of claim 17 and further comprising:
coloring the photo-luminescent to represent a particular hazardous material and package for transport within a facility.
